(19) United States
(12) Patent Application Publication
(10) Pub. No.: US 2006/0001354 A1
(43) Pub. Date: Jan. 5, 2006

(54) Transparent electrode for plasma display panel

(75) Inventors: Ko Ming Chen, Mailiao Village (TW); Chih Chung Peng, Mailiao Village (TW); Tsu Ching Lin, Mailiao Village (TW)

Correspondence Address: TROXELL LAW OFFICE PLLC;SUITE 1404, 5205 LEESBURG PIKE, FALLS CHURCH, VA, 22041, US

(73) Assignee: Formosa Plasma Display Corp.

(21) Appl. No.: 11/179,004

(22) Filed: Jun. 27, 2005

(30) Foreign Application Priority Data
Jun. 30, 2004 (TW) 093119431

(51) Int. Cl. H01J 1/62; H01J 63/04

(52) U.S. Cl. 313/491

(57) ABSTRACT

A specially designed transparent electrode for plasma display panel is disclosed. The transparent electrodes are disposed in pairs on the front glass substrate of the panel spaced apart and parallel to each other. The paired transparent electrodes X and Y are characterized by having respectively an extension member Xn and an extension member Yn projected from the opposing side of a strip-shaped base corresponding to each discharge cell of the panel. The extension member Xn and extension member Yn are asymmetrical in shape and spaced apart a predetermined distance, so as to enhance its field effect in the discharge cell with the address electrode on the rear substrate and increase the illumination efficiency of the discharge cell. In addition, the distances between extension member Xn and extension member Yn of each paired transparent electrodes X and Y corresponding to the red, green and blue discharge cells (R, G, B) in each pixel of the PDP are unequal.

### BACKGROUND OF INVENTION

1. Field of the Invention

The present invention relates to a kind of plasma display panel, more particularly a design of transparent electrode on the front substrate of the plasma display panel.

2. Description of the Prior Art

A conventional plasma display panel (PDP) typically comprises a front plate and a rear plate. The front plate comprises a glass substrate disposed thereon a plurality of paired and parallelly arranged scan electrodes and sustain electrodes and black stripes disposed on the side of each pair of scan electrode and sustain electrode and coated with in sequence a dielectric and an electrode protection layer thereon.

The rear plate comprises a glass substrate disposed with a plurality of parallelly arranged address electrodes coated with a dielectric layer, which has patterned barrier ribs formed thereon. The discharge cells defined between barrier ribs are deposited with three primary color phosphors (red, green and blue) in patterned distribution. The rear plate is aligned and sealed to the side surface of front plate. At the time of sealing, inert gases such as neon (Ne) and xenon (Xe) are charged and the address electrodes are arranged orthogonal to the paired scan electrode and sustain electrode of front plate so that a discharge space is formed at the place where the paired scan electrode and sustain electrode alternately intersects the address electrode, which corresponds to the discharge cell containing one primary color phosphor on the inner wall of barrier rib. As such, when a voltage is applied to the PDP, the inert gases therein are ionized to generate plasma and give off ultraviolet rays to excite the red, green and blue phosphors between the barrier ribs, which in turn emit visible red, green and blue lights, and under the driving of predetermined circuit, produce full-color images of different levels.

In the PDP described above, the plurality of scan electrodes and sustain electrodes are transparent electrodes made of light-transmitting and conductive material, such as ITO or SnO₂ to keep them from blocking the emission of plasma-excited rays. Also in light that large amount of heat is generated in the process of plasma generation that tends to raise the resistance of transparent electrodes and affect the stability of voltage for gas discharge, a straight metal bus electrode with width smaller than the transparent electrode is added to each transparent electrode as an auxiliary to enhance its conductivity.

In the aforementioned PDP structure, the transparent electrodes disposed on the front glass substrate provides light transmission and conductivity to create electrical fields with the address electrode of rear plate above and below the discharge cells deposited with red, green or blue phosphor when voltage is applied to the PDP, so that the ionized inert gases in the discharge cell would generate plasma to excite the phosphors to emit red, green or blue lights, which shine through the transparent electrodes. But the straight-strip design of the transparent electrodes tends to play down its field effect in discharge cells, thus affecting the generation of plasma to excite the phosphors to glow.

### SUMMARY OF INVENTION

The primary object of the present invention is to provide a kind of transparent electrode for plasma display panel to improve its illumination efficiency.

To achieve the aforesaid object, the paired transparent electrodes X and Y parallelly arranged and spaced part on the front glass substrate respectively have an extension member Xn and an extension member Yn projected from the opposing side of a strip-shaped base corresponding to each discharge cell of the panel. The extension member Xn and extension member Yn are asymmetrical in shape and spaced apart from each other.

The asymmetrical shape design of the extension member Xn and extension member Yn of the paired transparent electrodes is matched with the address electrode on rear substrate plate such that when voltage is applied to the PDP, the field effect in individual discharge cells may be converged to enhance the generation of plasma to excite the phosphors to glow.

### BRIEF DESCRIPTION OF THE DRAWINGS

The details of the present invention will be more readily understood from a detailed description of the preferred embodiments taken in conjunction with the following figures.

FIG. 1 is a schematic diagram of the first embodiment according to the invention.

FIG. 2 is a schematic diagram of the first embodiment according to the invention showing unequal distance between extension members X1 and extension members Y1.

FIG. 3 is a schematic diagram of the second embodiment according to the invention.

FIG. 4 is a schematic diagram of the second embodiment according to the invention showing unequal distance between extension members X2 and extension members Y2.

FIG. 5 is a schematic diagram of the third embodiment according to the invention.

FIG. 6 is a schematic diagram of the third embodiment according to the invention showing unequal distance between extension members X3 and extension members Y3.

FIG. 7 is a schematic diagram of the fourth embodiment according to the invention.

FIG. 8 is a schematic diagram of the fourth embodiment according to the invention showing unequal distance between extension members X4 and extension members Y4.

FIG. 9 is a schematic diagram of the fifth embodiment according to the invention.

FIG. 10 is a schematic diagram of the fifth embodiment according to the invention showing unequal distance between extension members X5 and extension members Y5.

FIG. 11 is a schematic diagram of the sixth embodiment according to the invention.

FIG. 12 is a schematic diagram of the sixth embodiment according to the invention showing unequal distance between extension members X6 and extension members Y6.

FIG. 13 is a schematic diagram of the seventh embodiment according to the invention showing unequal distance between extension members X7 and extension members Y7.

FIG. 14 is a schematic diagram of the eighth embodiment according to the invention showing unequal distance between extension members X8 and extension members Y8.

FIG. 15 is a schematic diagram of the ninth embodiment according to the invention showing unequal distance between extension members X9 and extension members Y9.

FIG. 16 is a schematic diagram of the tenth embodiment according to the invention showing unequal distance between extension members X10 and extension members Y10.

### DETAILED DESCRIPTION

FIG. 1 illustrates an embodiment of the transparent electrode for plasma display panel according to the present invention. As shown, the transparent electrodes are in pairs and formed parallel and spaced apart on the glass substrate of front plate of PDP. The paired transparent electrodes X and Y each have a strip-shaped base (10, 20) of predefined width, and an extension member X1 and an extension member Y1 are projected from the opposing side of the base corresponding to each discharge cell of the PDP. The extension member X1 and extension member Y1 are asymmetrical in shape and spaced apart from each other.

The shapes of extension member X1 and extension member Y1 may have at least the following designs as illustrated in the embodiments.

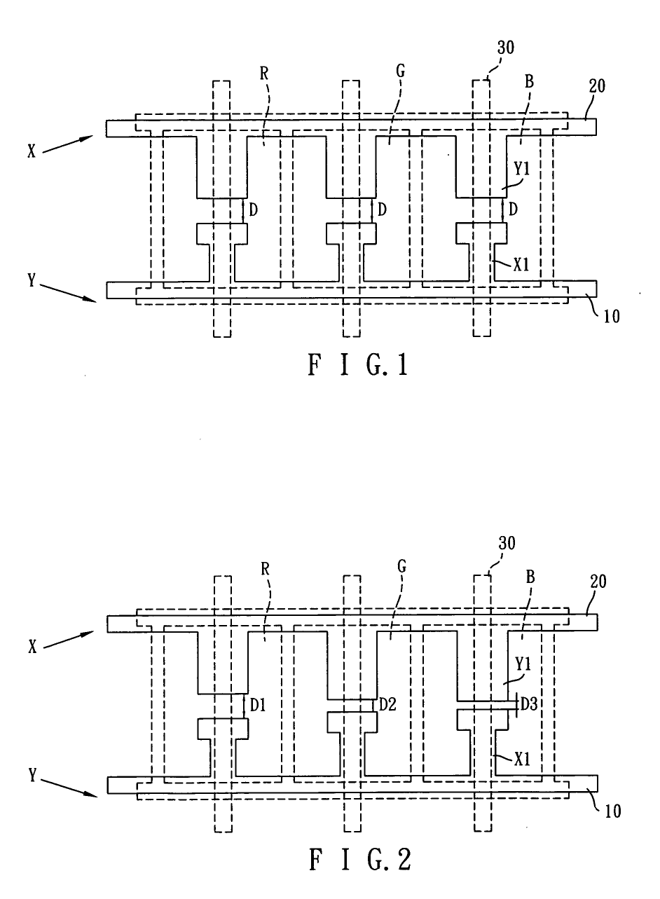

In the first embodiment of the present invention, either extension member X1 or extension member Y1 is in T-shaped and the other is square-shaped. As shown in FIG. 1, extension member X1 is T-shaped and extension member Y1 is square-shaped, while the broader end of the T-shaped extension member X1 faces extension member Y1 and has the same width as that of the opposing end of extension member Y1, and the distances D between extension member X1 and extension member Y1 of each paired transparent electrodes X and Y corresponding to the red, green and blue discharge cells (R, G, B) in each pixel of the PDP are equal. Or as shown in FIG. 2, the distances D₁, D₂ and D₃ between extension member X1 and extension member Y1 of each paired transparent electrodes X and Y corresponding to the red, green and blue discharge cells (R, G, B) in each pixel of the PDP are unequal, wherein the distance D1 corresponding to red discharge cell (R) is greater than the distance D₂ corresponding to green discharge cell (G), and the distance D₂ corresponding to green discharge cell (G) is greater than the distance D₃ corresponding to blue discharge cell (B).

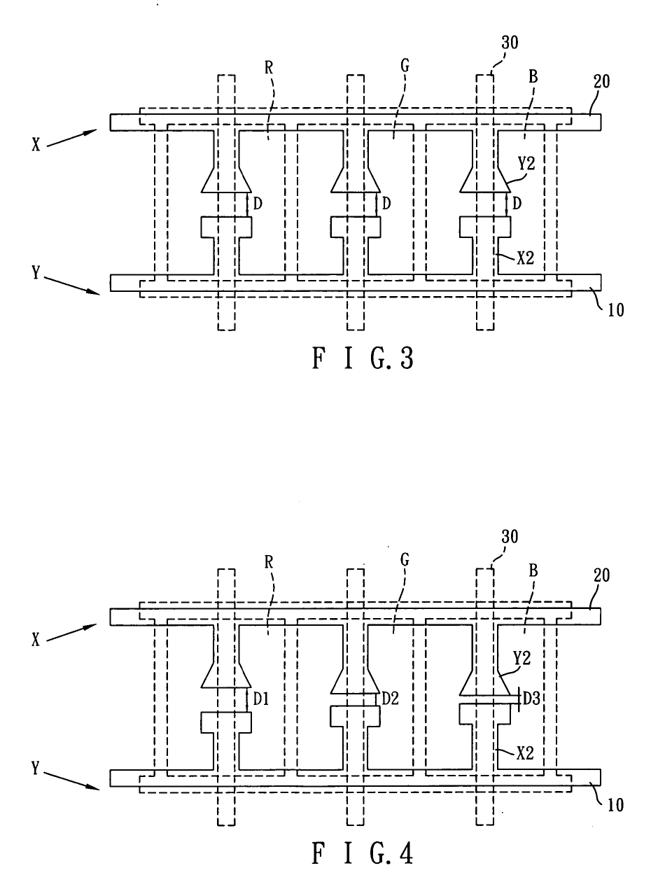

In the second embodiment of the invention, either extension member X2 or extension member Y2 is in T-shaped and the other is square-shaped and flat ended with a widening triangle. As shown in FIG. 3, the extension member X2 is T-shaped and extension member Y2 is square-shaped and flat ended with a widening triangle, while the broader end of the T-shaped extension member X2 faces the broader end of the widening triangle of extension member Y2, and the distances D between extension member X2 and extension member Y2 of each paired transparent electrodes X and Y corresponding to the red, green and blue discharge cells (R, G, B) in each pixel of the PDP are equal. Or as shown in FIG. 4, the distances D₁, D₂ and D₃ between extension member X2 and extension member Y2 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

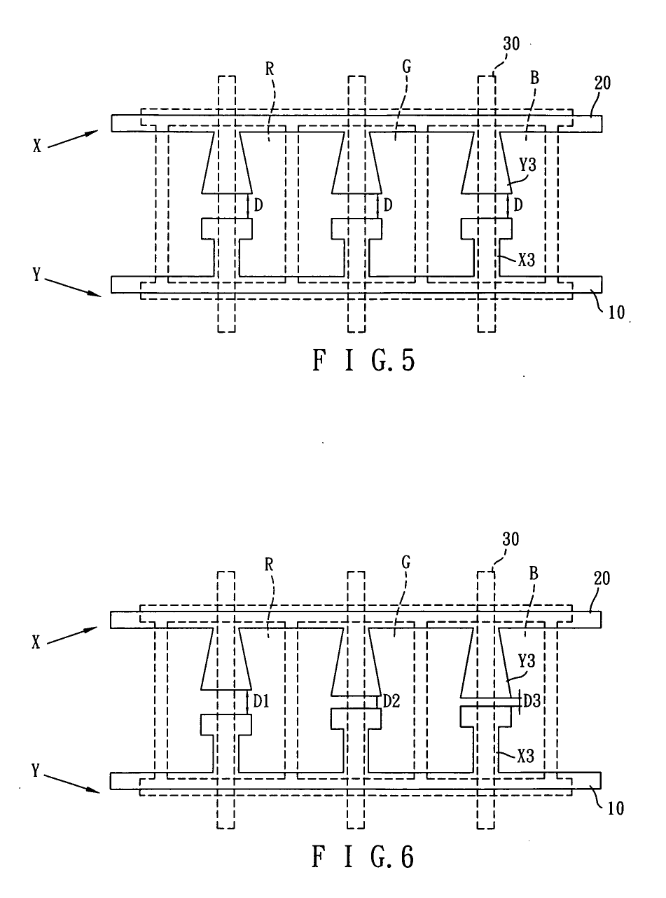

In the third embodiment of the invention, either extension member X3 or extension member Y3 is in T-shaped and the other is in trapezoid shape with its broader end facing the broader end of T-shaped configuration. As shown in FIG. 5, the extension member X3 is a T-shaped protrusion and extension member Y3 is a trapezoid protrusion, while the broader ends of the T-shaped protrusion and the trapezoid protrusion face each other, and the distances D between extension member X3 and extension member Y3 of each paired transparent electrodes X and Y corresponding to the red, green and blue discharge cells (R, G, B) in each pixel of the PDP are equal. Or as shown in FIG. 6, the distances D₁, D₂ and D₃ between extension member X3 and extension member Y3 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

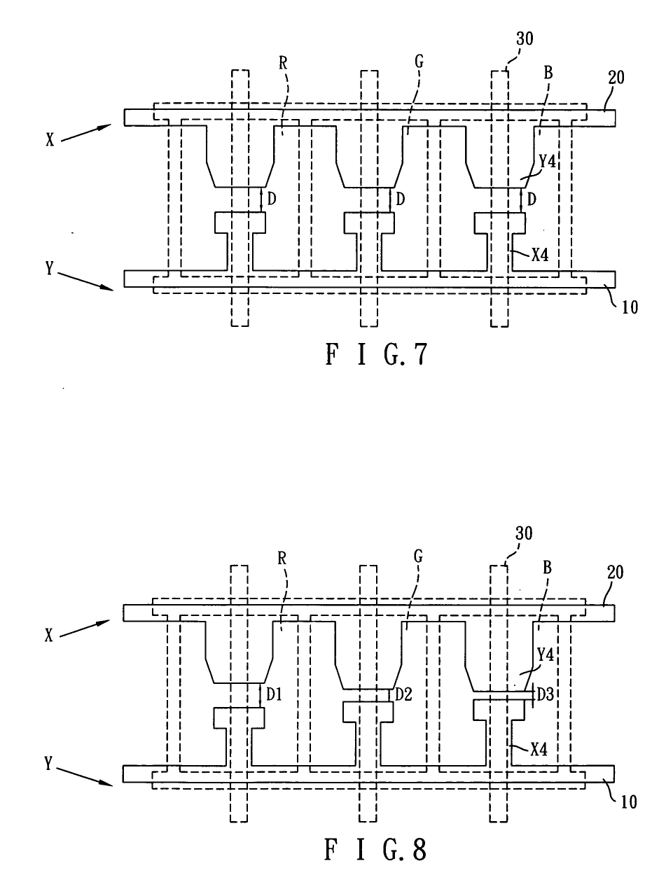

In the fourth embodiment of the invention, either extension member X4 or extension member Y4 is in T-shaped and the other is a square-shaped protrusion with width slightly greater than the broader end of the T-shaped configuration and having both side ends opposing extension member X4 cut. As shown in FIG. 7, the extension member X4 has a T-shaped configuration and the extension member Y4 is a square-shaped protrusion with width slightly greater than the broader end of the T-shaped configuration and its both side ends opposing extension member X4 are cut, so that the end of extension member Y4 and the opposing end of extension member X4 are equal in width. In addition, the distances D between extension member X4 and extension member Y4 of each paired transparent electrodes X and Y corresponding to the red, green and blue discharge cells (R, G, B) in each pixel of the PDP are equal. Or as shown in FIG. 8, the distances D₁, D₂ and D₃ between extension member X4 and extension member Y4 of each paired transparent electrodes X and Y corresponding to the red, green and blue discharge cells (R, G B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

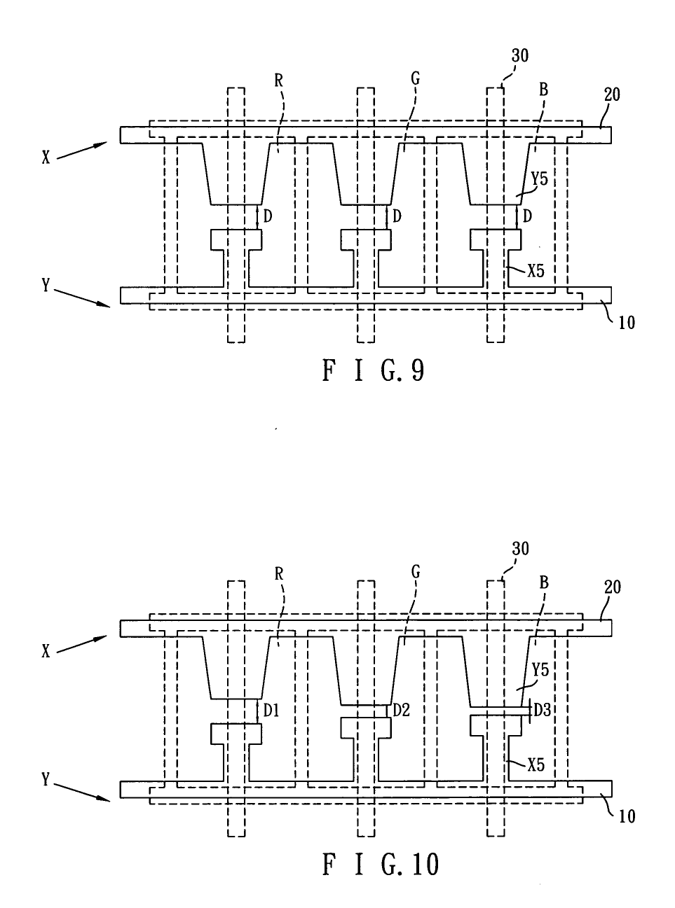

In the fifth embodiment of the invention, either extension member X5 or extension member Y5 is in T-shaped and the other is in trapezoid shape with its narrow end facing the broader end of T-shaped configuration. As shown in FIG. 9, the extension member X5 is a T-shaped protrusion and extension member Y5 is a trapezoid protrusion with its narrow end facing the broader end of T-shaped extension member X5 and the width of the narrow end being equal to the opposite broader end of extension member X5. In addition, the distances D between extension member X5 and extension member Y5 of each paired transparent electrodes X and Y corresponding to the red, green and blue discharge cells (R, G, B) in each pixel of the PDP are equal. Or as shown in FIG. 10, the distances D₁, D₂ and D₃ between extension member X5 and extension member Y5 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

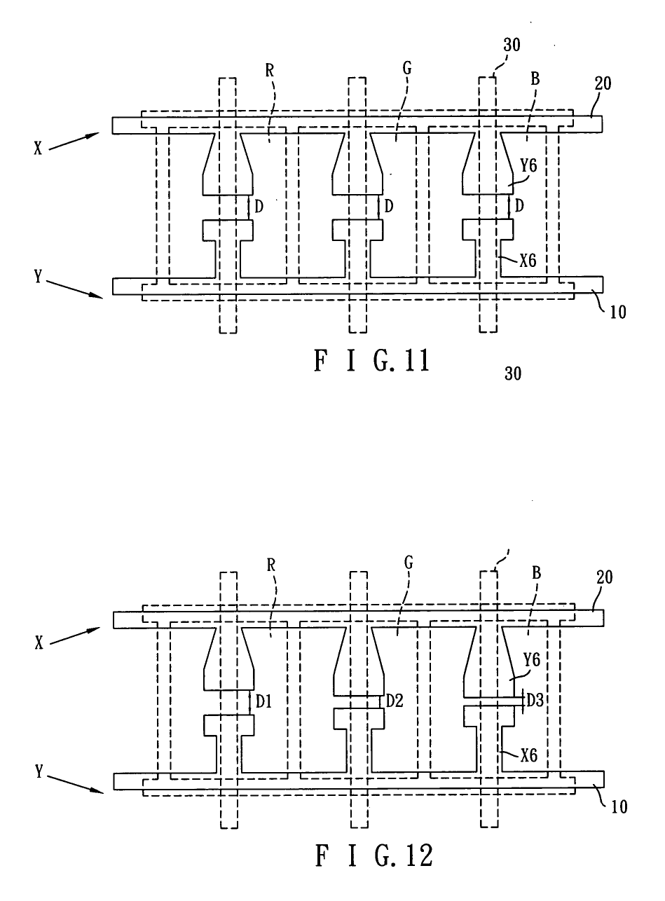

In the sixth embodiment of the invention, either extension member X6 or extension member Y6 is in T-shaped and the other is a square-shaped protrusion with width comparable to the broader end of the T-shaped configuration and having both side ends nearing its base cut. As shown in FIG. 11, the extension member X6 has a T-shaped configuration and the extension member Y6 is a square-shaped protrusion with width comparable to the broader end of the T-shaped configuration and its both side ends nearing the base 20 are cut. In addition, the distances D between extension member X6 and extension member Y6 of each paired transparent electrodes X and Y corresponding to the red, green and blue discharge cells (R, G, B) in each pixel of the PDP are equal. Or as shown in FIG. 12, the distances D₁, D₂ and D₃ between extension member X6 and extension member Y6 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

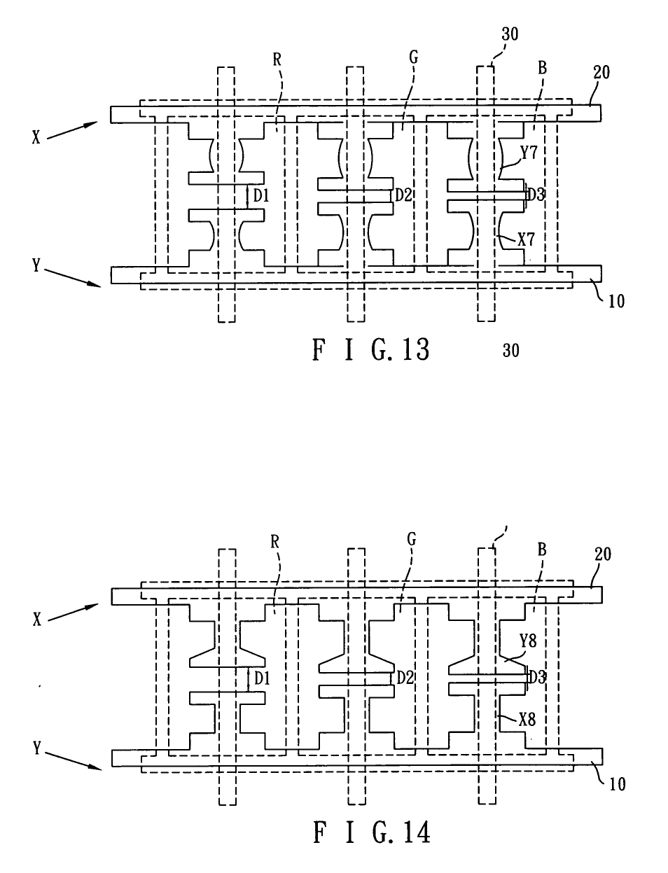

In the seventh embodiment of the invention, extension members X7 and Y7 are both in I-shaped and both having a broader bottom portion adjacent to the strip-shaped base (10 or 20), a neck portion extending out from the broader bottom portion, and a broader head portion which is substantially parallel to the strip-shaped bases (10 and 20). However, either one of the extension members X7 or Y7 has its neck portion being narrowed in middle, while the other one has its neck portion being widened in middle. As shown in FIG. 13, the extension member X7 is in the I-shaped configuration having a neck portion being narrowed in middle, while the extension member Y7 is also in the I-shaped configuration having a neck portion being widened in middle. In addition, the distances D₁, D₂ and D₃ between extension member X7 and extension member Y7 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

In the eighth embodiment of the invention, extension members X8 and Y8 are both in I-shaped and both having a broader bottom portion adjacent to the strip-shaped base (10 or 20), a neck portion extending out from the broader bottom portion, and a broader head portion which is substantially parallel to the strip-shaped bases (10 and 20). However, either one of the extension members X8 or Y8 has its broader head portion being a widening triangle, while the other one has its broader head portion being an elongated rectangular strip. As shown in FIG. 14, the extension member X8 is in the I-shaped configuration having its broader head portion being an elongated rectangular strip, while the extension member Y8 is also in the I-shaped configuration having its broader head portion being a widening triangle. In addition, the distances D₁, D₂ and D₃ between extension member X8 and extension member Y8 of each paired transparent electrodes X and Y corresponding to the red, green and blue discharge cells (R, G, B) in each pixel of the PDP are unequal, wherein the distance D1 corresponding to red discharge cell (R) is greater than the distance D₂ corresponding to green discharge cell (G), and the distance D₂ corresponding to green discharge cell (G) is greater than the distance D₃ corresponding to blue discharge cell (B).

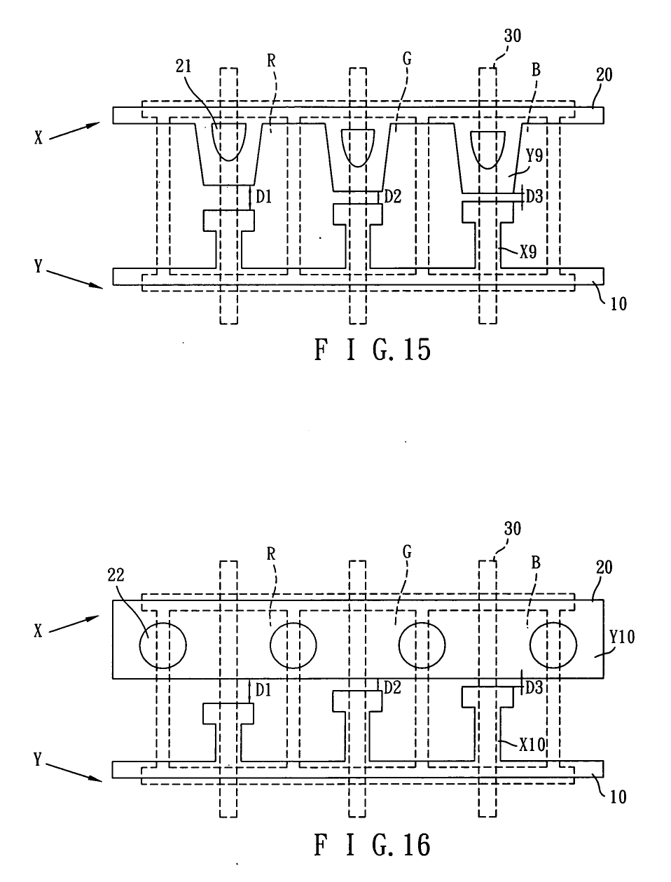

In the ninth embodiment of the invention, either extension member X9 or extension member Y9 is in T-shaped and the other is in trapezoid shape with its narrow end facing the broader end of T-shaped configuration. In addition, a semicircular opening is formed on the trapezoid shaped extension member. As shown in FIG. 15, the extension member X9 is in the T-shaped configuration having its broader end portion facing the extension member Y9, while the extension member Y9 is in trapezoid shape with its narrow end facing the broader end of T-shaped extension member X9. A semicircular opening 21 is formed on the trapezoid shaped extension member Y9. In addition, the distances D₁, D₂ and D₃ between extension member X9 and extension member Y9 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

In the tenth embodiment of the invention, either extension member X10 or extension member Y10 is in T-shaped and the other is a wide strip extending parallel to the strip-shaped base (10 or 20). A plurality of round openings are formed on the wide strip shaped extension member. Each of the T-shaped extension members is apart from and facing the middle of two adjacent openings. As shown in FIG. 16, the extension member X10 is in the T-shaped configuration having its broader end portion facing the extension member Y10, while the extension member Y10 is a wide strip extending parallel to the strip-shaped base (10 or 20) and having a plurality of round openings 22 formed thereon. Each T-shaped extension member X10 is apart from and facing the middle of two adjacent openings 22 of the extension member Y10. In addition, the distances D₁, D₂ and D₃ between extension member X10 and extension member Y10 of each paired transparent electrodes X and Y corresponding to the red, green and blue discharge cells (R, G, B) in each pixel of the PDP are unequal, wherein the distance D₁ corresponding to red discharge cell (R) is greater than the distance D₂ corresponding to green discharge cell (G), and the distance D₂ corresponding to green discharge cell (G) is greater than the distance D₃ corresponding to blue discharge cell (B).

The designs disclosed above aim to render extension member Xn and extension member Yn of each paired electrodes in the discharge cell asymmetrical in shape and correspond to the address electrode on rear plate so that when voltage is applied to the PDP, the field effects in individual discharge cell are converged to enhance the illumination efficiency of phosphors as excited by the plasma and increase the luminance of the PDP. Also in light of the different illumination efficiency of three primary color phosphors, the distances between extension member Xn and extension member Yn corresponding to each set of red, green and blue discharge cells are designed to be unequal to enhance the color temperature effect of the panel.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. Transparent electrodes for plasma display panel, comprising:
at least one transparent electrode X, each having a first strip-shaped base of predefined width and a plurality of extension members Xn protruding out of the first strip-shaped base; and
at least one transparent electrode Y, each having a second strip-shaped base of predefined width and a plurality of extension members Yn protruding out of the second strip-shaped base, said transparent electrodes X and Y being formed in pairs and parallelly arranged spaced apart on a front glass substrate of the panel so as to form discharge cells therebetween for emitting either red, green or blue light, said extension members Xn and extension members Yn being opposing to each other in pairs;
wherein, each pair of the extension member Xn and extension member Yn are asymmetrical in shape and spaced apart from each other;
wherein, distances between each pair of extension members Xn and Yn corresponding to red, green and blue discharge cells of the plasma display panel are unequal.

2. The transparent electrodes according to claim 1, wherein either the extension member Xn or Yn is a T-shaped protrusion and the other one is a square-shaped protrusion, wherein a broader end of the T-shaped protrusion faces the square-shaped protrusion and width of the square-shaped protrusion is substantially equal to the broader end of T-shaped protrusion.

3. The transparent electrodes according to claim 1, wherein either the extension member Xn or Yn is a T-shaped protrusion and the other one is square-shaped and flat ended with a widening triangle, wherein a broader end of the widening triangle faces a broader end of the T-shaped protrusion.

4. The transparent electrodes according to claim 1, wherein either the extension member Xn or Yn is a T-shaped protrusion and the other one is in trapezoid shape with its broader end facing a broader end of T-shaped protrusion.

5. The transparent electrodes according to claim 1, wherein either the extension member Xn or Yn is a T-shaped protrusion and the other one is a square-shaped protrusion with width slightly greater than a broader end of the T-shaped protrusion and having both side ends opposing the T-shaped protrusion cut, and the broader end of T-shaped protrusion faces the cut end of square-shaped protrusion.

6. The transparent electrodes according to claim 1, wherein either the extension member Xn or Yn is a T-shaped protrusion and the other one is in trapezoid shape with its narrow end facing a broader end of the T-shaped protrusion.

7. The transparent electrodes according to claim 1, wherein either the extension member Xn or Yn is a T-shaped protrusion and the other one is a square-shaped protrusion with width substantially equal to a broader end of the T-shaped protrusion and having both side ends nearing its base cut.

8. The transparent electrodes according to claim 1, wherein the extension members Xn and Yn are both in I-shaped and each of the extension members Xn and Yn has a broader bottom portion adjacent to the base, a neck portion extending out from the broader bottom portion, and a broader head portion substantially parallel to the base, in addition, either one of the extension members Xn or Yn has its neck portion being narrowed in middle, while the other one has its neck portion being widened in middle.

9. The transparent electrodes according to claim 1, wherein the extension members Xn and Yn are both in I-shaped and each of the extension members Xn and Yn has a broader bottom portion adjacent to the base, a neck portion extending out from the broader bottom portion, and a broader head portion substantially parallel to the base, in addition, either one of the extension members Xn or Yn has its broader head portion being a widening triangle, while the other one has its broader head portion being an elongated rectangular strip.

10. The transparent electrodes according to claim 1, wherein either extension member Xn or extension member Yn is in T-shaped and the other is in trapezoid shape with its narrow end facing a broader end of the T-shaped extension member, in addition, a semicircular opening is formed on the trapezoid shaped extension member.

11. The transparent electrodes according to claim 1, wherein either extension member Xn or extension member Yn is in T-shaped and the other is a wide strip extending parallel to the strip-shaped base, a plurality of round openings are formed on the wide strip shaped extension member, the T-shaped extension member is apart from and facing a middle of two adjacent openings.

12. The transparent electrode according to claim 1, wherein the distance between extension member Xn and extension member Yn corresponding to red discharge cell is greater than the distance between extension member Xn and extension member Yn corresponding to green discharge cell, and the distance between extension member Xn and extension member Yn corresponding to green discharge cell is greater than the distance between extension member Xn and extension member Yn corresponding to blue discharge cell.
